(19) United States
(12) Patent Application Publication
(10) Pub. No.: US 2010/0029206 A1
(43) Pub. Date: Feb. 4, 2010

(54) COMMUNICATION DEVICE, STORAGE MEDIUM THAT RECORDS COMMUNICATION CONTROL PROGRAM, AND COMMUNICATION CONTROL METHOD

(75) Inventor: Yuei KUMAGAI, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/511,376

(22) Filed: Jul. 29, 2009

(30) Foreign Application Priority Data
Jul. 31, 2008 (JP) 2008-197139

(51) Int. Cl. H04B 7/00

(52) U.S. Cl. 455/41.2

(57) ABSTRACT

The system includes a storage unit that stores a number of times of receiving a reference request received by the communication unit, a comparison unit that totals the number of times of receiving the reference request stored in the storage unit when the communication unit receives the reference request, and then compares a given number of times and the number of times of receiving the reference request stored in the storage unit, and a control unit that makes the communication unit transmit a reference response in response to the reference request received by the communication unit if the number of times of receiving the reference request is less than or equal to the given number of times, and makes the communication unit transmit no response in response to the reference request if the number of times of receiving the reference request is more than the given number of times.

### CROSS-REFERENCE TO RELATED APPLICATIONS

This application is based upon and claims the benefit of priority of the prior Japanese Patent Application No. 2008-197139, filed on Jul. 31, 2008, the entire contents of which are incorporated herein by reference.

### BACKGROUND

In recent years, the wireless functionality of various devices has advanced because of the convenience of structures without cables. In particular, Bluetooth (R), a radio communication specification, has been used as a short-distance communication specification of data and voice for various devices such as a PC and PC peripheral equipment. Compared to Wireless Local Area Network (Wireless LAN) employed by radio devices as well, the Bluetooth has a characteristic of low consumption power and is suitable for a mouse, a keyboard, and a mobile phone which are powered by a battery.

To connect the above-described communication device using the Bluetooth and other radio communication devices with each other, information used to specify a connection partner, such as an address of the connection partner, is required. For example, when the Bluetooth devices are connected with each other for the first time, the following reference procedure is performed. At first, a master side device transmits a reference request to obtain information of the device to which the master side device is connected. After receiving the reference request, a slave side device includes the information of the device itself in a reference response and then transmits the reference response to the master side device. Next, the master side device receives the reference response and then recognizes that the slave side device is connectable.

In this regard, there is a known technique for automatically switching a detection mode of response permission or response rejection according to a place of use selected by a user, for example, in an office or during movement.

There is another known technique for switching the mode to an undetectable mode after the connection with another radio device is completed. There is another known technique for ending the processing if no response is received even when the Bluetooth device radiates electromagnetic waves for a given number of times to detect the device on the other side.

There is another known technique for turning off the power of a device when the device receives no electronic wave from a base station even when a channel scanning operation is performed for a set number of times if the radio communication device is outside of the service area.

### SUMMARY

According to an aspect of the invention, a communication device includes: a communication unit that transmits and receives a radio signal, a storage unit that stores a given number of times and a number of times of receiving a reference request received by the communication unit, a comparison unit that totals the number of times of receiving the reference request stored in the storage unit when the communication unit receives the reference request, and then compares the given number of times and the number of times of receiving the reference request stored in the storage unit, and a control unit that makes the communication unit transmit a reference response in response to the reference request received by the communication unit if the number of times of receiving the reference request is less than or equal to the given number of times, and makes the communication unit transmit no response in response to the reference request if the number of times of receiving is more than the given number of times.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

FIG. 1 is a diagram illustrating an overview of the present embodiment,

FIG. 2 is a diagram illustrating a hardware configuration of a slave side communication device,

FIG. 3 is a diagram illustrating a hardware configuration of a master side communication device,

FIG. 4 is a block diagram illustrating a configuration of the slave side communication device,

FIG. 5 is a diagram illustrating a configuration example of an address table,

FIG. 6 is a flowchart illustrating a procedure of reference response determination processing, and

FIG. 7 is a sequence diagram illustrating a procedure at the time of referring.

### DETAILED DESCRIPTION OF THE PREFERRED EMBODIMENTS

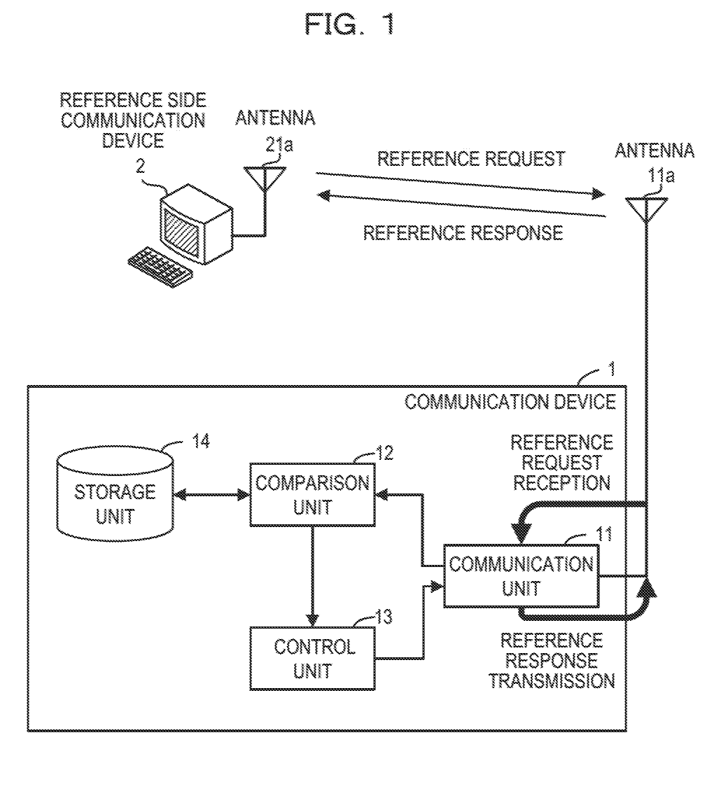

With reference to the diagrams, description will be made below of an embodiment. FIG. 1 is a diagram illustrating an overview of the present embodiment. A communication device 1 illustrated in FIG. 1 determines whether or not to respond to a reference request from a reference side communication device 2. If yes, the communication device 1 transmits a reference response. The communication device 1 includes a communication unit 11, a comparison unit 12, a control unit 13, and a storage unit 14. The communication unit 11 is connected to an antenna 11a.

The communication unit 11 transmits and receives a radio signal by radio communication performed between the communication device 1 and the reference side communication device 2. At this time, the communication between the communication device 1 and the reference side communication device 2 is performed through the antenna 11a connected to the communication unit 11 and the antenna 21a connected to the reference side communication device 2.

A reference request and a reference response for the connection between the communication device 1 and the reference side communication device 2 are also transmitted and received through the radio communication by the communication unit 11. That is, the reference request transmitted from the reference side communication device 2 is received by the communication unit 11. The reference response to the received reference request is transmitted by the communication unit 11 according to control by the control unit 13.

In this case, the reference request is a message transmitted from the reference side communication device 2 to request a surrounding communication device (for example, the communication device 1 and the like) to transmit a reference response to connect with the surrounding communication device. The reference response is a message sent by the communication device 1, which received the reference request transmitted from the reference side communication device 2, in response to the reference request.

When the communication unit 11 receives the reference request transmitted from the reference side communication device 2, the comparison unit 12 adds one to the number of times of receiving the reference request stored in the storage unit 14. Furthermore, the comparison unit 12 compares a given number of times stored in the storage unit 14 to the number of times of receiving to which one is added.

According to the comparison result from the comparison unit 12, if the number of times of receiving is less than the given number of times, the control unit 13 makes the communication unit 11 transmit the reference response in response to the reference request received by the communication unit 11. On the other hand, if the number of times of receiving is more than the given number of times, the control unit 13 sends no response, so that the communication unit 11 transmits no reference response.

The storage unit 14 stores the given number of times and the number of times of receiving a reference request from the communication unit 11. According to the above-described communication device 1, the communication unit 11 transmits and receives the radio signal. The storage unit 14 stores the given number of times and the number of times of receiving the reference request. The comparison unit 12 adds one to the number of times of receiving the reference request when the reference request is received, and then compares the given number of times and the number of times of receiving. If the number of times of receiving is less than the given number of times according to the comparison result from the comparison unit 12, the control unit 13 makes the communication unit 11 transmit the reference response. If the number of times of receiving is more than the given number of times, the communication unit 11 transmits no response.

Therefore, the control unit 13 does not to transmit the reference response if the number of times of receiving the reference request is more than the given number of times. This makes it possible to prevent wasteful transmission of the reference request of the communication device 1, so that the power consumption may be reduced.

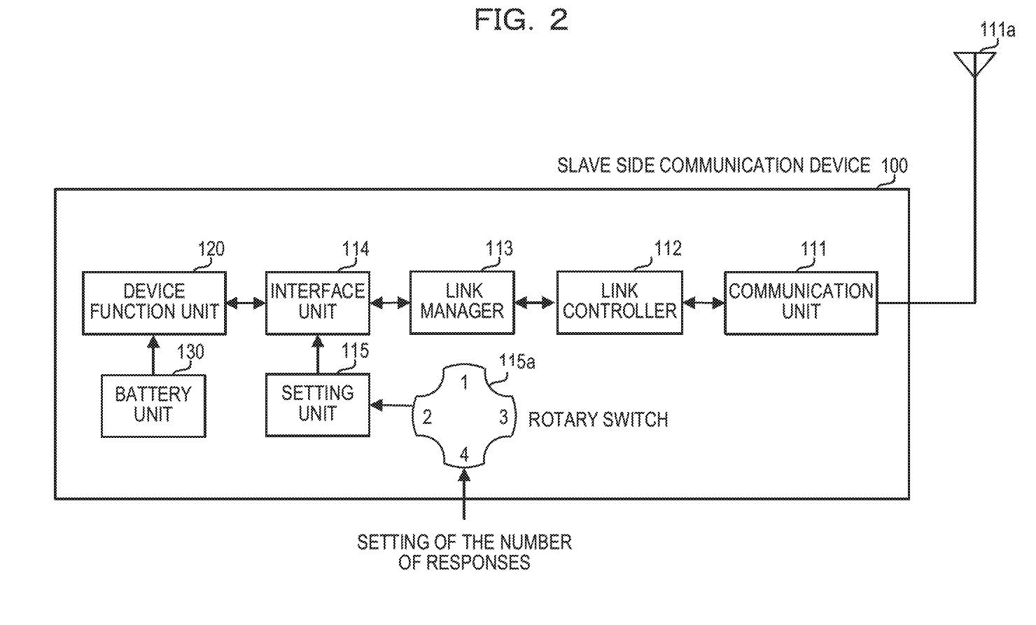

Next, detailed description will be made of an embodiment of the above-described communication device. FIG. 2 is a diagram illustrating a hardware configuration of a slave side communication device. A slave side communication device 100 includes a communication unit 111, a link controller 112, a link manager 113, an interface unit 114, a setting unit 115, a device function unit 120, and a battery unit 130.

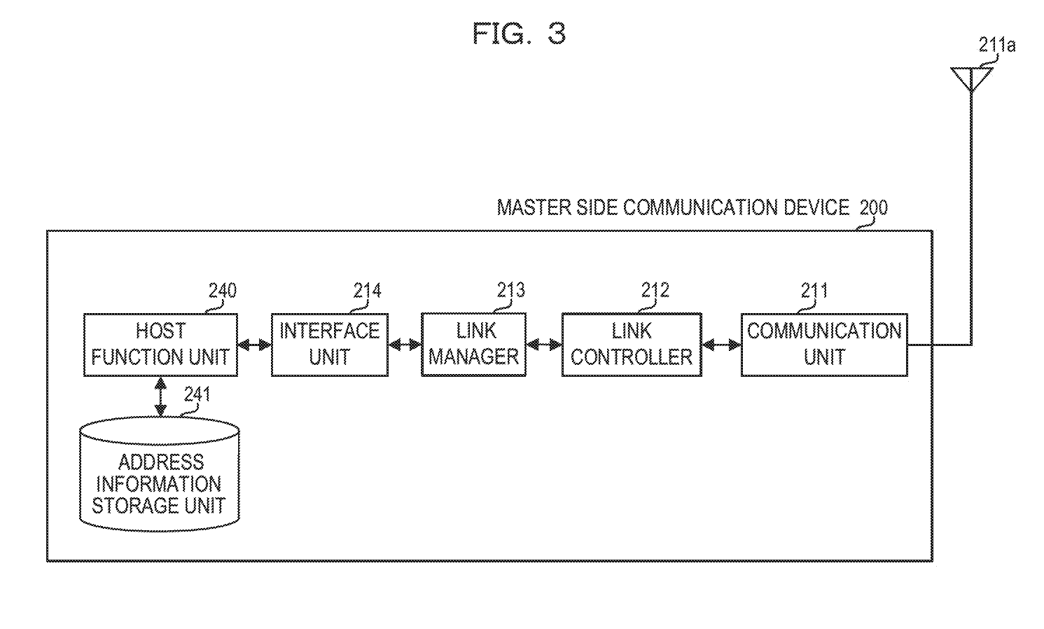

The communication unit 111 includes a Radio Frequency (RF) circuit for radio communication in compliance with the Bluetooth and a modulation and demodulation circuit for transmission and reception signals, and is radio-connected to a master side communication device 200 (see FIG. 3) through an antenna 111a to transmit and receive data. The slave side communication device 100 may transmit and receive the data by performing radio-communication with the master side communication device 200 through the communication unit 111 and the antenna 111a.

To establish a radio link, the link controller 112 performs communication connection processing, such as connection request, connection authentication processing, and the like, between the slave side communication device 100 and the master side communication device 200. The link manager 113 performs processing for establishing a radio link, signal encoding and decoding processing, and the like.

In the slave side communication device 100, the link controller 112 and the link manager 113 perform the communication in compliance with the Bluetooth between the slave side communication device 100 and the master side communication device 200.

The interface unit 114 receives a signal transmitted from the setting unit 115 or the device function unit 120 and then transmits the signal to the link manager 113. The setting unit 115, which is connected to a rotary switch 115a, receives a signal transmitted from the rotary switch 115a and then transmits the signal to the interface unit 114.

The rotary switch 115a receives setting operation of the number of reference responses set by a user and then transmits the signal in accordance with the setting operation to the setting unit 115. As the rotary switch 115a, a mechanical switch such as a DIP switch may be used, or an input device other than a mechanical switch may also be used.

The device function unit 120 indicates a part in which a function provided in the slave side communication device 100 is achieved. For example, if the slave side communication device 100 is a keyboard, the device function unit 120 indicates the part that functions as a keyboard.

While the data that is output by the function of the device function unit 120 is transmitted to the master side communication device 200 by the link manager 113, the link controller 112, and the communication unit 111 through the interface unit 114, the data from the master side communication device 200 is received by the communication unit 111, the link controller 112, and the link manager 113 and is then input to the device function unit 120.

The slave side communication device 100 may be a mouse, a wireless headphone, a wireless speaker, or the like. The battery unit 130 has a battery (not shown) to supply electric power to operate the slave side communication device 100. This battery has a chargeable secondary cell such as a nickel hydride battery. The battery is charged by an AC adaptor (not shown) provided inside or outside the slave side communication device 100, and by a charge circuit (not shown). Not only the above-described secondary cell, any kind of secondary cell such as a lithium-ion cell may be applicable.

The slave side communication device 100 of the present embodiment is operated by the battery included in the battery unit 130. The slave side communication device 100 may be operated by being supplied with electric power from another power source such as a 100-volt commercial power source. Moreover, switch use or combination use of the battery is applicable.

The communication unit 111 of the present embodiment transmits and receives the data by the radio communication in compliance with the Bluetooth. The radio communication in compliance with the Bluetooth is illustrated as an example. The communication unit 111 is applicable to other communication devices operated by other communication specifications with the similar communication procedure.

FIG. 3 is a diagram illustrating a hardware configuration of a master side communication device. The master side communication device 200 includes a communication unit 211, a link controller 212, a link manager 213, an interface unit 214, a host function unit 240, and an address information storage unit 241.

As with the communication unit 111 illustrated in FIG. 2, the communication unit 211 includes a Radio Frequency (RF) unit for radio communication in compliance with the Bluetooth, a modulation and demodulation circuit, and the like, and transmits and receives the data by being radio-connected to the slave side communication device 100 (described above in FIG. 2) through an antenna 211a. In this master side communication device 200, data transmission and reception may be performed by performing the radio communication with the slave side communication device 100 through the communication unit 211 and the antenna 211a.

As with the link controller 212 illustrated in FIG. 2, the link controller 212 performs communication connection processing, such as connection request or connection authentication processing, between the link controller 112 and the slave side communication device 100 to establish a radio link.

As with the link manager 113 illustrated in FIG. 2, the link manager 213 performs processing for establishing a radio link, signal encoding and decoding processing, and the like. In the master side communication device 200, the communication in compliance with the Bluetooth between the master side communication device 200 and the slave side communication device 100 is performed by the link controller 212 and the link manager 213.

The interface unit 214 receives a signal transmitted from the host function unit 240 and then transmits the signal to the link manager unit 213. The host function unit 240 indicates the part that achieves a function as an information processing device in the master side communication device 200.

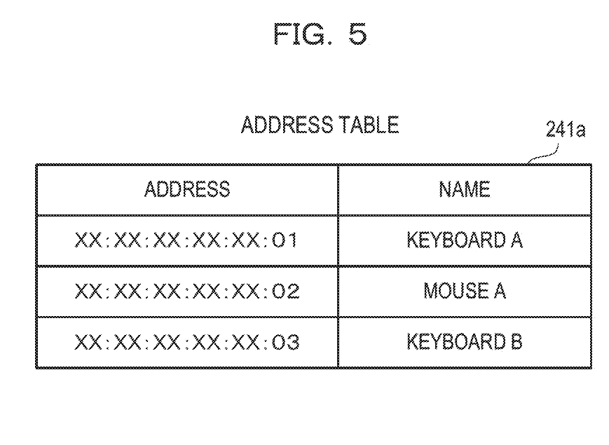

The address information storage unit 241 stores the address information used to manage the connection with the slave side communication device 100. The address information storage unit 241 will be described in detail in FIG. 5.

The communication unit 211 of the present embodiment transmits and receives the data by the radio communication in compliance with the Bluetooth. The radio communication in compliance with the Bluetooth is illustrated as an example. The communication unit 211 is applicable to other communication devices operated by other communication specifications with the similar communication procedure.

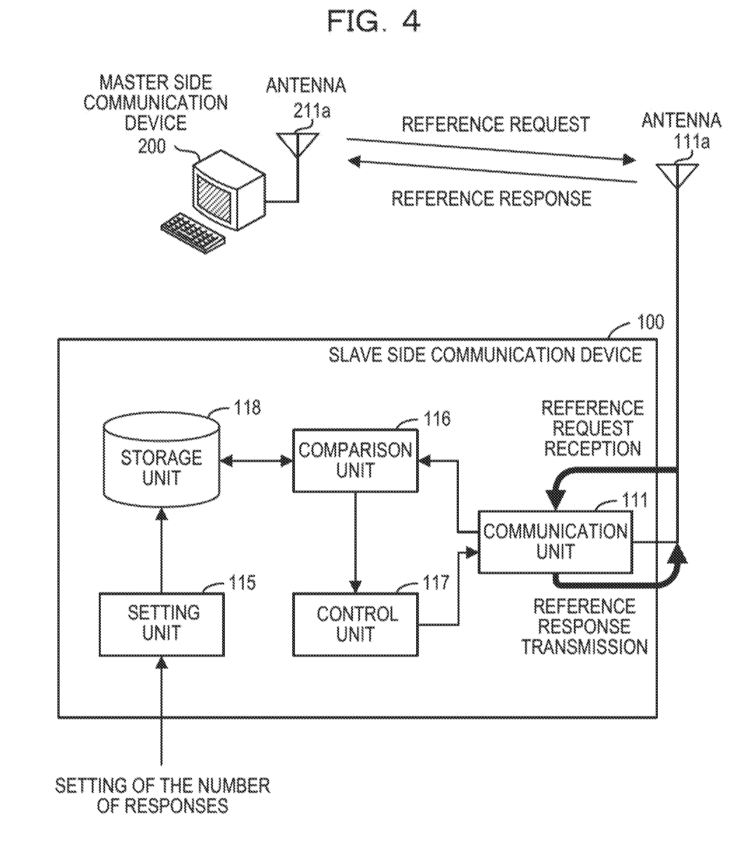

The above-described hardware configuration achieves the processing function of the present embodiment. FIG. 4 is a block diagram illustrating a configuration of the slave side communication device. The slave side communication device 100 illustrated in FIG. 4 determines whether or not to respond to the reference request from the master side communication device 200. If yes, the slave side communication device 100 has a function for transmitting a reference response.

The slave side communication device 100 is a device compliant with the Bluetooth standards and includes a communication unit 111, a setting unit 115, a comparison unit 116, a control unit 117, and a storage unit 118. The communication unit 111 is connected to the antenna 111a.

The slave side communication device 100 is a slave device operated by being connected to a master device that transmits a reference request. The slave side communication device is operated by the battery included in the battery unit 130 (described above in FIG. 2) to perform the radio communication that is compliant with the Bluetooth standards. The slave side communication device 100 may be operated by a primary battery.

In general, to perform pairing, a radio communication device compatible with the Bluetooth performs the reference procedure when a surrounding radio communication device compatible with the Bluetooth is found (detected) or when the radio communication device is found from the surrounding radio communication devices.

The reference side radio communication device (for example, the master side communication device 200) that attempts to find the surrounding radio communication device transmits a reference request one time or more times repeatedly. After receiving the reference request, the radio communication device (for example, the slave side communication device 100), which may be found from the surrounding radio communication devices, transmits the reference response in response to the reference request.

The communication unit 111 transmits and receives a radio signal by the radio communication performed between the slave side communication device 100 and the master side communication device 200. At this time, the communication between the slave side communication device 100 and the master side communication device 200 is performed through the antenna 111a connected to the communication unit 111 and the antenna 211a connected to the communication unit 211 (described above in FIG. 3) included in the master side communication device 200.

Furthermore, a reference request and a reference response for the connection between the slave side communication device 100 and the master side communication device 200 are transmitted and received through the radio communication by this communication unit 111. That is, the reference request transmitted from the master side communication device 200 is received through the communication unit 111. The reference response in response to the received reference request is transmitted by the communication unit 111 according to control by the control unit 117.

In this case, the reference request is a message from the master side communication device 200 to request a reference response to the surrounding communication device to connect to the surrounding communication device (for example, the slave side communication device 100 and the like). The reference response is a message to be sent as a reply by the slave side communication device 100 that received the reference request transmitted from the master side communication device 200 in response to the reference request.

This reference response includes a Bluetooth address inherent to the slave side communication device 100 that transmitted the reference response. Accordingly, the master side communication device 200 that received the reference response may obtain the Bluetooth address of the slave side communication device 100. By using the obtained Bluetooth address, the master side communication device 200 performs the radio communication in compliance with the Bluetooth with the slave side communication device 100.

The setting unit 115, which is connected to the rotary switch 115a (described above in FIG. 2), sets a given number of times based on the operation of the rotary switch 115a by a user. When the communication unit 111 receives the reference request transmitted from the master side communication device 200, the comparison unit 116 adds one to the number of times of receiving the reference request stored in the storage unit 118. Furthermore, the comparison unit 116 compares the given number of times (the number of reference responses) stored in the storage unit 118 to the number of times of receiving to which one is added.

According to the result from the comparison unit 116, if the number of times of receiving is equal to or less than the given number of times, the control unit 117 makes the communication unit 111 transmit the reference response in response to the reference request received by the communication unit 111. On the other hand, if the number of times of receiving is more than the given number of times, the control unit 117 makes the communication unit 111 transmit no response in response to the reference request. According to the result from the comparison unit 116, if the number of times of receiving is less than the given number of times, the control unit 117 makes the communication unit 116 transmit a reference response. If the number of times of receiving is equal to or more than the given number of times, the control unit 117 transmits no response in response to the reference request.

The storage unit 118 stores the given number of times and the number of times of receiving the reference request received by the communication unit 111. The number of times of receiving stored in the storage unit 118 is cleared by turning off the power of the slave side communication device 100. In this manner, when the power of the slave side communication device 100 is turned off, the number of times of receiving stored in the storage unit 118 is cleared. This allows the slave side communication device 100, which has stopped transmitting a response, to transmit a given number of reference responses again.

Next, description will be made of a data configuration example of the data used in the present embodiment. FIG. 5 is a diagram illustrating a configuration example of an address table. An address table 241a illustrated in FIG. 5 is formed and managed by the master side communication device 200 (described above in FIG. 3) and is stored in an address information storage unit 241 (described above in FIG. 3). The address table 241a is a table that stores address information indicating a correspondence relation between an address included in the slave side communication device and a name of each of the slave side communication devices so that the master side communication device 200 manages the connection with each slave side communication device.

The address table 241a has an “address” as an item indicating a Bluetooth address (IEEE 802 address) inherent to each of the slave side communication devices to specify the slave side communication device, and a “name” as an item indicating a name used by a user to specify the slave side communication device. The information of each item arranged in a row is associated with each other to constitute address information.

The address is data used by the master side communication device 200 to specify each slave side communication device. According to the reference request transmitted by the master side communication device 200, the reference response is transmitted to the master side communication device 200 from the slave side communication device 100. At this time, the slave side communication device 100 includes the Bluetooth address inherent to the slave side communication device 100 in a reference response, and then transmits the reference response. After receiving this reference response, the master side communication device 200 detects the Bluetooth address of the slave side communication device 100 from the received reference response and then stores the Bluetooth address in the address table 241a.

The name is a name used by a user to specify the slave side communication device allocated in each slave side communication device (for example, the slave side communication device 100) found by the master side communication device 200.

At this time, in the master side communication device 200 of the present embodiment, the address information is formed by pairing based on the reference operation by the master side communication device 200 and then is stored in the address information storage unit 241.

Based on this address information, the master side communication device 200 displays, to the user, a list of the slave side communication devices that responded to the reference request. Based on the list of the displayed slave side communication devices, the user may recognize the slave side communication device that is connectable to the master side communication device 200. Furthermore, the master side communication device 200 allows the user to select the slave side communication device that is to be connected to the master side communication device 200.

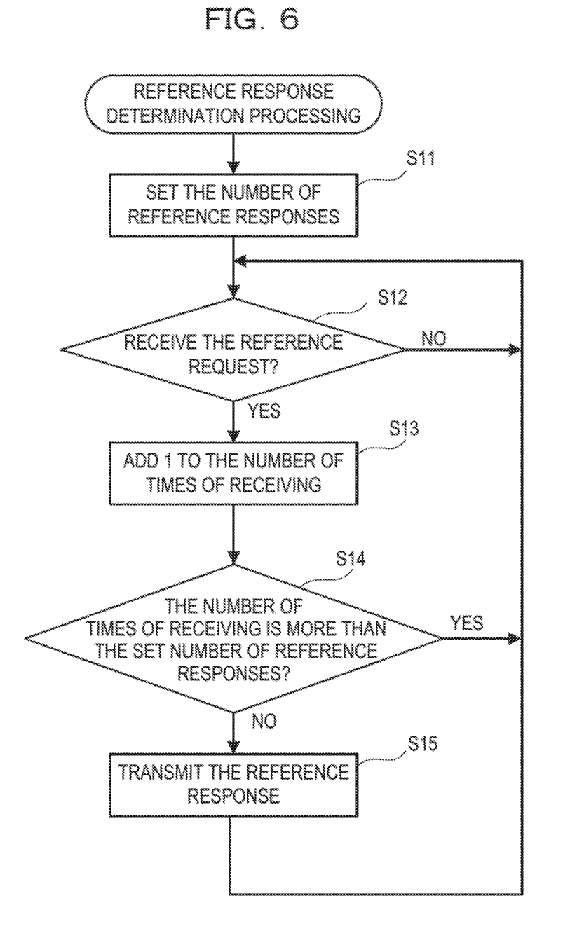

Next, description will be made of processing performed in the present embodiment. FIG. 6 is a flowchart illustrating a procedure of reference response determination processing. The reference response determination processing is processing by the slave side communication device 100 to determine whether or not to perform reference response by counting the reference request, and is performed after the completion of starting the slave side communication device.

At this time, the reference request to be transmitted from the master side communication device 200 is transmitted when the master side communication device 200 and the slave side communication device 100 are connected for the first time if the master side communication device 200 and the slave side communication device 100 have never been connected to each other before. That is, the reference request is transmitted in a state where the Bluetooth address of the slave side communication device 100 is not stored in the address table 241a (described above in FIG. 5) of the address information storage unit 241 (described above in FIG. 3) in the master side communication device 200. Therefore, if the master side communication device 200 and the slave side communication device 100 have been connected to each other before, and if the Bluetooth address of the slave side communication device 100 is stored in the address table 241a, the master side communication device 200 transmits no reference request and performs direct communication by using the Bluetooth address of the slave side communication device 100 stored in the address table 241a.

[Step S11]

The slave side communication device 100 sets the number of reference responses as the number of times of transmitting a reference response in response to the reference request. Specifically, the setting unit 115 stores the number of reference responses in the storage unit 118 (described above in FIG. 4). At this time, the setting unit 115 obtains the setting of the rotary switch 115a and stores the obtained setting in the storage unit 118.

[Step S12]

The slave side communication device 100 determines whether or not the reference request is received from the master side communication device 200 (described above in FIG. 3). If the reference request is received, the process goes to step S13. On the other hand, if the reference request is not received, the process of step S12 is repeated until the reference request is received.

[Step S13]

The slave side communication device 100 adds one to the number of times of receiving the reference request stored in the storage unit 118. Accordingly, the number of reference requests received by the slave side communication device 100 is counted.

[Step S14]

The slave side communication device 100 determines whether or not the number of times of receiving the reference request stored in the storage unit 118 is more than the number of reference responses set in step S11. If the number of times of receiving is less than the set number of reference responses, the process goes to step S15. On the other hand, if the number of times of receiving is more than the set number of reference responses, the slave side communication device 100 transits to a non-response state, and the process goes to step S12 without transmitting a reference response.

The power of the slave side communication device 100 that has transited to the non-response state is turned off by the user, and then the number of times of receiving stored in the storage unit 118 is cleared. This enables the slave side communication device 100 to again transmit the reference response for the number of reference responses.

[Step S15]

The slave side communication device 100 transmits the reference response to the master side communication device 200 that transmitted the received reference request. The Bluetooth address of the slave side communication device 100 is included in the reference response and then the reference response is transmitted. The master side communication device 200 that received this reference response may obtain the Bluetooth address of the slave side communication device 100. After that, the slave side communication device 100 finishes the processing.

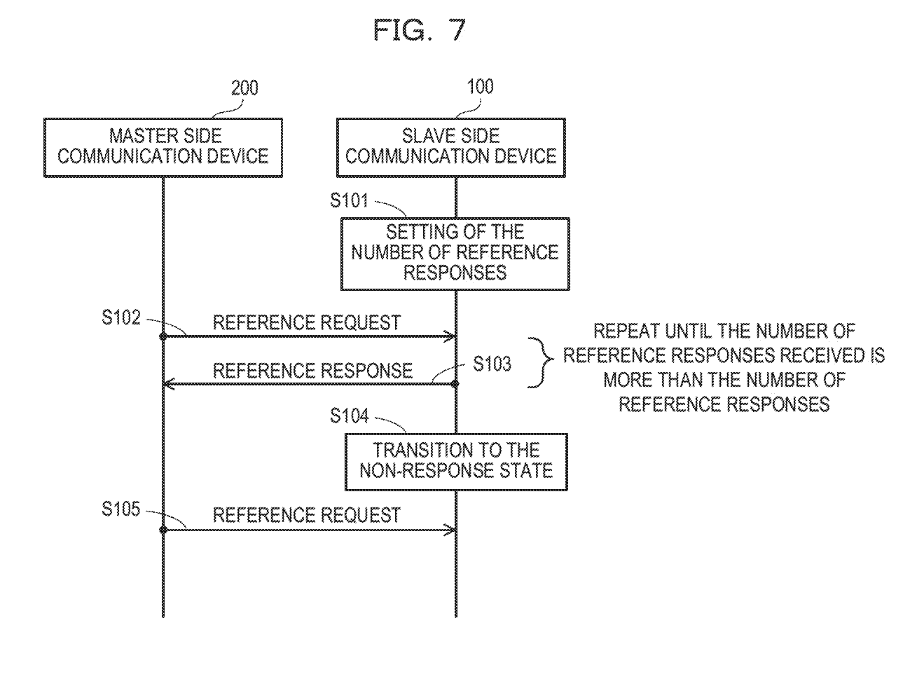

FIG. 7 is a sequence diagram illustrating a procedure at the time of referring. Description will be made below of the procedures at the time of referring between the slave side communication device 100 and the master side communication device 200.

[Step S10]

The slave side communication device 100 stores the number of reference responses in the storage unit 118 and then sets the number of reference responses.

[Step S102]

The master side communication device 200 transmits the reference request to the slave side communication device 100.

[Step S103]

The slave side communication device 100 transmits, to the master side communication device 200, the reference response in response to the reference request received in step S102. The above-described step S102 and step S103 are repeated until the number of reference responses received by the slave side communication device 100 is more than the number of reference responses set in step S10.

[Step S104]

When receiving the number of reference responses more than the set number of reference responses, the slave side communication device 100 transits to the non-response state in which the slave side communication device 100 transmits no reference response even though the reference request is received from the master side communication device 200. This non-response state is released depending on whether or not the power of the slave side communication device 100 is turned off or whether or not a reset switch (not shown) is operated.

[Step S105]

The master side communication device 200 transmits the reference request to the slave side communication device 100. Since the slave side communication device 100 transits to the non-response state in which the slave side communication device 100 transmits no reference response in step S104, the slave side communication device 100 transmits no reference response in response to this reference request.

As described above, according to the present embodiment, it is possible to prevent transmission of useless reference responses by the slave side communication device 100. This may reduce power consumption of the slave side communication device 100.

In the present embodiment, the data is transmitted and received through radio communication in compliance with the Bluetooth between the communication unit 111 and the communication unit 211. The radio communication in compliance with the Bluetooth is illustrated as an example. The radio communication in compliance with the Bluetooth is applicable to communication devices operated by other communication specifications with the similar communication procedure.

The above-described processing function may be achieved by a computer. In this case, a program that describes a processing content of the function that the slave side communication device 100 should have is provided. By performing this program in a computer, the above-described processing function is achieved on the computer.

The program that describes the processing content may be recorded in a computer-readable record medium. The computer-readable record medium includes a magnetic recording device, an optic disk, an optic magnetic recording medium, a semiconductor memory, and the like. The magnetic recording device includes an HDD, a flexible disk (FD), a magnetic tape (MT), and the like. The optic disk includes a Digital Versatile Disc (DVD), a DVD-RAM, a Compact Disc-Read Only Memory (CD-ROM), a Compact Disc-Recordable (CD-R)/ReWritable (CD-RW), and the like. The optic magnetic recording medium includes a Magneto-Optical disk (MO) and the like.

To distribute the above-described program, for example, a mobile recording medium, such as a DVD and a CD-ROM in which this program is recorded, is sold. Furthermore, the program may be stored in a server computer and then transferred to another computer from the server computer.

The computer that performs the above-described program stores, in a storage device of the computer itself, for example, a program recorded in a mobile recording medium or a program transferred from the server computer. Then the computer reads the program from the storage device of the computer itself and performs processing corresponding to the program. The computer may read the program directly from the mobile recording medium and perform the processing corresponding to the program. Furthermore, every time when the program is transferred from the server computer, the computer may successively perform the processing corresponding to the program.

The disclosed communication device, communication control program, and communication control method were described above based on the illustrated embodiment. The configuration of each unit may be replaced with any configuration having similar functions. Furthermore, any other component or process may be added to the disclosed technique. Furthermore, the disclosed technique may have a configuration formed by combining more than two configurations of the above-described embodiment.

The above description simply indicates the principle of the invention. All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A communication device comprising:
a communication unit that transmits and receives a radio signal,
a storage unit that stores a number of times of receiving a reference request received by the communication unit,
a comparison unit that totals the number of times of receiving the reference request stored in the storage unit when the communication unit receives the reference request, and then compares a given number of times and the number of times of receiving the reference request stored in the storage unit, and
a control unit that makes the communication unit transmit a reference response in response to the reference request received by the communication unit if the number of times of receiving the reference request is less than or equal to the given number of times, and makes the communication unit transmit no response in response to the reference request if the number of times of receiving the reference request is more than the given number of times.

2. The communication device according to claim 1, wherein the number of times of receiving the reference request stored in the storage unit is cleared by turning off the power of the communication device.

3. The communication device according to claim 1, wherein the communication device is operated by a battery.

4. The communication device according to claim 1, further comprising a setting unit that sets the given number of times based on a user's operation.

5. The communication device according to claim 1, wherein a slave device is operated by being connected to a master device that transmits the reference request.

6. The communication device according to claim 1, wherein radio communication which complies with Bluetooth standards is performed.

7. A communication control method for controlling a communication device having a communication unit that transmits and receives a radio signal, wherein the communication control method comprises:
storing, by a control unit, a given number of times, and a number of times of receiving a reference request received by the communication unit in a storage unit,
comparing, by a comparison unit, the given number of times and the number of times of receiving the reference request stored in the storage unit by totaling the number of times of receiving the reference request stored in the storage unit when the communication unit receives the reference request, and
transmitting a reference response in response to the reference request received by the communication unit if the number of times of receiving the reference request is less than or equal to the given number of times, and then transmitting no response in response to the reference request if the number of times of receiving the reference request is more than the given number of times.

8. A computer-readable recording medium that records a communication control program for controlling a communication device having a communication unit that transmits and receives a radio signal, the computer-readable recording medium causing the communication device to serve as:
a control unit that stores a given number of times and a number of times of receiving a reference request received by the communication unit in a storage unit,
a comparison unit that totals the number of times of receiving the reference request stored in the storage unit when the communication unit receives the reference request, and then compares the given number of times and the number of times of receiving the reference request stored in the storage unit, and
a control unit that makes the communication unit transmit a reference response in response to the reference request received by the communication unit if the number of times of receiving the reference request is less than or equal to the given number of times, and makes the communication unit transmit no response in response to the reference request if the number of times of receiving the reference request is more than the given number of times.
